(19) United States
(12) Patent Application Publication
(10) Pub. No.: US 2021/0257686 A1
(43) Pub. Date: Aug. 19, 2021

(54) BATTERY CELL HOLDER STRUCTURE WITH HEAT TRANSFER ASSEMBLY

(71) Applicant: Baidu USA LLC, Sunnyvale, CA (US)

(72) Inventor: Tianyi Gao, Sunnyvale, CA (US)

(21) Appl. No.: 16/792,367

(22) Filed: Feb. 17, 2020

(51) Int. Cl. H01M 10/613; H01M 10/6552; H01M 10/6554; H01M 10/6556; H01M 10/6561; H01M 10/6551

(52) U.S. Cl. CPC H01M 10/613; H01M 10/6552; H01M 10/6551; H01M 10/6556; H01M 10/6561; H01M 10/6554

(57) ABSTRACT

A heat transfer system includes a chassis with an inlet end and an outlet end to receive a cooling airflow from the inlet end to the outlet end. The heat transfer system also includes a number of conducting holders for holding a battery cells within the chassis. The cell packaging holder includes a heat transfer design for transferring heat from the outlet end of the chassis to the inlet end of the chassis.

### FIELD OF THE DISCLOSURE

Embodiments of the present invention relate generally to electronics and server thermal management. More particularly, embodiments of the invention relate to a battery heat transfer system.

### BACKGROUND

Existing cell packaging solutions for a battery backup unit (BBU) use regular cell holders for assembling the cells in the BBU module. This may not be a proper solution for thermal management of the cells during their discharging cycle, due to the large amount of the heat generated during this cycle period. With the cell being covered with the holder, the amount of airflow passing over the cell surface is reduced. Particular challenges arise because of the significant difference in temperature between the front row of battery cells, which are closer to the air inlet, and the back rows of battery cells.

### BRIEF DESCRIPTION OF THE DRAWINGS

Embodiments of the invention are illustrated by way of example and not limitation in the figures of the accompanying drawings in which like references indicate similar elements.

FIG. 1 shows a battery heat transfer system design with conducting plates, according to embodiments of the present disclosure.

FIG. 2 shows another view of the battery heat transfer system of FIG. 1, according to embodiments of the present disclosure.

FIG. 3 shows a battery heat transfer system design with vapor chambers, according to embodiments of the present disclosure.

FIG. 4 shows a battery coo heat transfer ling system design with vertical vapor chambers, according to embodiments of the present disclosure.

FIG. 5 shows a representation of a battery cell holder design, according to embodiments of the present disclosure.

FIG. 6 shows another representation of a battery cell holder design, according to embodiments of the present disclosure.

FIG. 7 shows a cross-sectional view of a battery cell holder and cell assembly, according to embodiments of the present disclosure.

### DETAILED DESCRIPTION

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Embodiments of the present disclosure facilitate thermal management within a high density cell package, which can be used as a battery backup unit, especially during the cell discharging time. During this period, the cell generates a large amount of heat, and the design of the cell arrangement and airflow arrangement may result in very large thermal gradients among the cells. This not only causes a safety issue for normal operation, but also significantly impacts on the cell life time and entire BBU module life time.

The thermal management of a high density cell package module requires the ability to manage the cell temperature under specific values, such as 75° C. during operation including both charging and discharging periods, especially given the limitations of the air cooling design. The number of fans available is limited due to space limitations, and the amount of airflow is limited due to high flow resistance. Even if a solution is able to manage most of the cells under 75° C.; however, sensors may not be able to detect and represent the cell temperature status for every battery cell. It may be possible that some of the cells have hot spots. These hot spot cells may cause a negative impact on the entire system performance, since these cells age faster. When some of the cells are aging, it does not only impact the performance itself, it impacts the entire module as well due to the fact the cells are balancing the load internally. In some cases, when the cells are at different health statuses, malfunctions of the system, or even catastrophic damage can occur.

Embodiments of the present disclosure provide a high density cell packaging and thermal management solution by introducing the phase change cell holder. In some embodiments, the cell holder utilizes a phase change structure for managing the heat generated by the cells to transfer and distribute the heat within the cell holder package.

In some embodiments, a phase change structure, such as a heat pipe or vapor chamber, helps remove the heat generated by the cells from the back rows to the front rows of cells when the temperatures are in high difference. Heat is typically concentrated in the front portion of the battery pack where the airflow inlet is located. In another embodiment, the battery cell holder extracts and conducts as much heat as possible within the time to the base chamber using phase change techniques. This enables the heat to be transferred to the holder and managed by the airflow more efficiently. In some embodiments, conductive holders may be used in two sides of the cells, such as left side and right hand side, between the cells and other components. In other embodiments, vertical vapor chambers can be used in vertical locations from the top side of the battery cells.

### System Overview

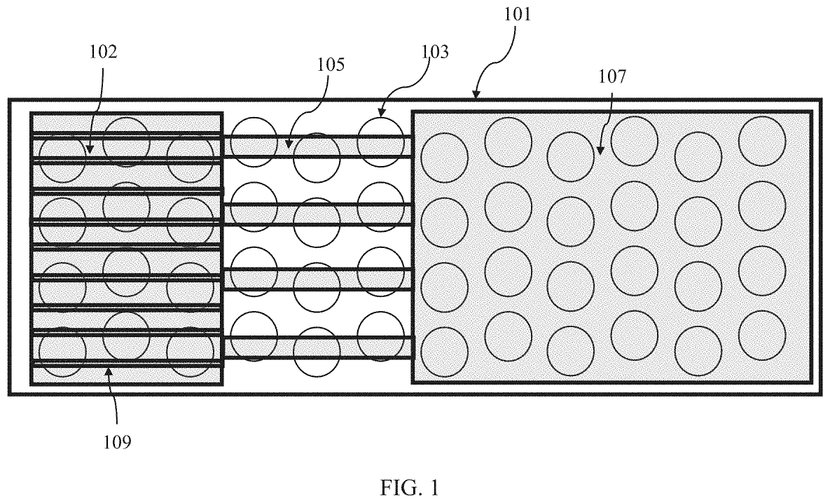

FIG. 1 shows a battery heat transfer system design with conducting plates, according to embodiments of the present disclosure. In this embodiment, the battery heat transfer system includes a housing or chassis 101, which holds a number of battery cells 103. The heat transfer system includes three major sections, in this embodiment, including an evaporating plate 107, a condensing plate 102, and one or more heat pipes 105 for transferring heat between the evaporating plate 107 and the condensing plate 102.

In some embodiments, the evaporating plate 107 is used for the cells at the back rows in terms of cooling air flow, where the airflow is warmest. The heat generated by the cells at the back can be quickly transferred to the evaporating plate 107, and the heat pipe 105 transfers the heat carried by the vapor to the front portion. In such embodiments, the latent heat captured within the vapor of the heat pipe 105 is extracted through the condensing plate 102, and at the same time, the vapor changes phase to liquid. In some embodiments, the cooling air is used for cooling the front rows of battery cells, as well as the condensing plate 102. The condensing plate can include cooling fins 109, in some embodiments.

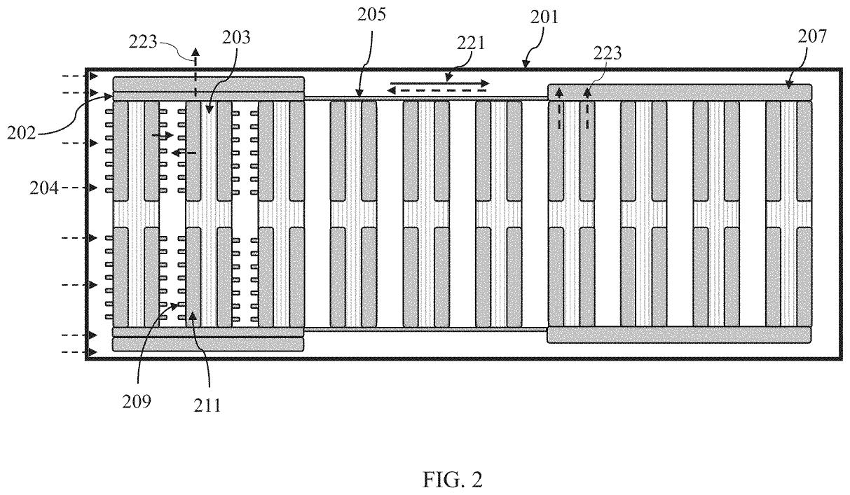

FIG. 2 shows another view of the battery heat transfer system of FIG. 1, according to one of the embodiments of the present disclosure. In this embodiment, the system includes a chassis 201, which holds a number of battery cells 203. The heat transfer system also includes one or more heat pipes 205, a condensing plate 202, and an evaporating plate 207. FIG. 2 illustrates the direction of airflow 204 from the left to the right, from the inlet end to the outlet end of the chassis 201. In this embodiment, the individual cells can be covered with a conducting holder 211, which includes a socket for receiving a battery cells, and is used for conducting the heat from the surface of each cell 203. In some embodiments, the conducting holder 211 can also include a plurality of fins 209 that can help dissipate heat from the surface of the cells 203. In one embodiment, FIG. 2 can be a side view of the system shown in FIG. 1, while in other embodiments FIG. 2 can be a top view of the system shown in FIG. 1.

In some embodiments, all the cells 203 can be covered with the conducting holder 211 on the surface. In such embodiments, an optimized solution can be based on a number of testing parameters, and design modifications can be made based on specific use cases. In FIG. 2, he direction of fluid flow within the heat pipe 205 is illustrated in solid line 221, while the direction of heat is shown in broken lines 223. In some embodiments, the heat from cells 203 on the second end of the chassis 201 (closer to the right side of FIG. 2), can travel initially through the conducting holders 211 and then toward the first end of the chassis 201 (to the left side of FIG. 2), where it can transfer to the condensing plate 202 and exit the system as shown in broken lines 223. In some embodiments, heat can be extracted to the air through multiple routes, such as through cooling fins 209 located on one or more of the conducting holders 211. In some embodiments, the conducting holders 211 or the heat pipes 205 can also serve to mount the cells 203 within the chassis 201, as well as enhance heat transfer from the cells 203. In some embodiments, the conducting holders 211 can assist with longitudinal heat transfer along a portion of the cells 203. In some embodiments, the cooling fins 209 located along all or a portion of the conducting holders 211 can assist with the longitudinal heat transfer along the cells 203.

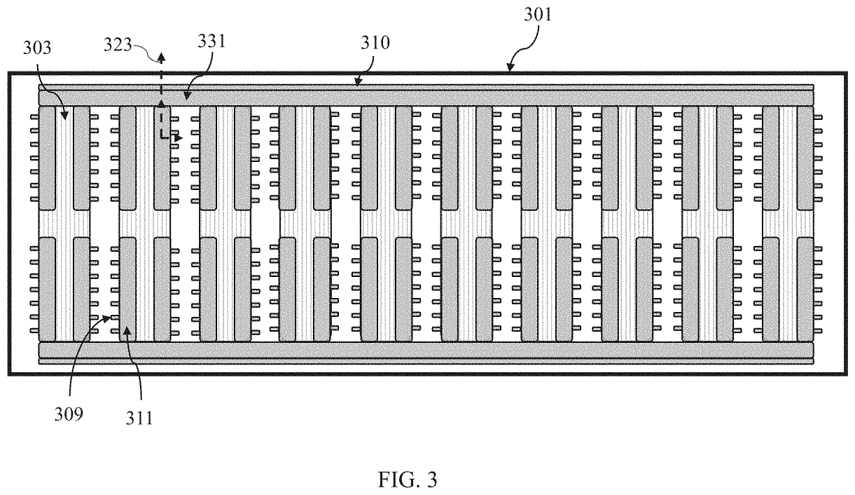

FIG. 3 shows a battery heat transfer system design with vapor chambers 331, according to embodiments of the present disclosure. In this embodiment, a chassis 301 houses a number of battery cells 303, which are in contact with one or more vapor chambers 331. In some embodiments, cooling fins 310 are assembled in contact with the vapor chambers 331 in order to enhance the air cooling performance.

In this embodiment, the battery cells 303 are also cooled using conducting holders 311 and cooling fins 309 located on the conducting holders, in addition to the vapor chambers 331. This helps remove heat from the cells 303 quickly through the conducting holders 311 via as many outlets as possible. Thus, heat can be removed from the cells through at least two paths, shown as dashed line 323, through the vapor chambers 331 and the cooling fins 309. In some embodiments, the cooling fins 310 associated with the vapor chambers 331 are located on the sides of the plates in order to optimize air flow between the battery cells 303.

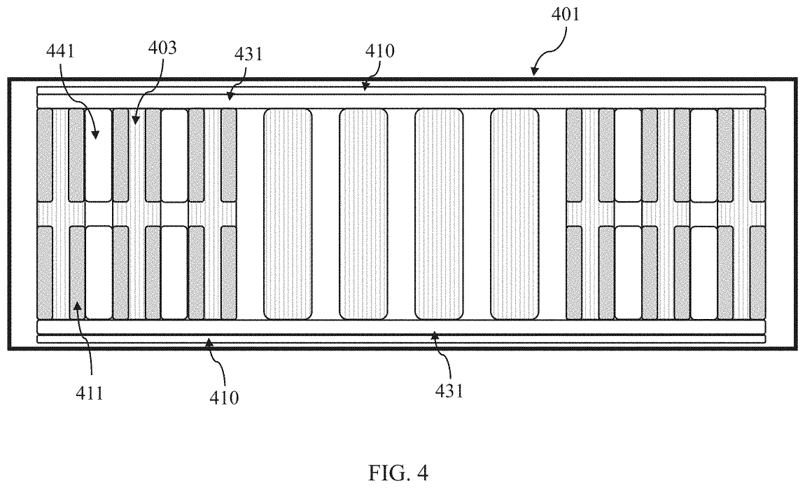

FIG. 4 shows a battery heat transfer system design with vertical vapor chambers 441, according to embodiments of the present disclosure. In this embodiment, a chassis 401 houses a number of battery cells 403, which are in contact with one or more horizontal vapor chambers 431, as well as one or more vertical vapor chambers 441. In some embodiments, cooling fins 410 are assembled in contact with the horizontal vapor chambers 431 in order to enhance the air cooling performance. In this embodiment, conducting holders 411, include a socket for receiving the battery cells 403 and also function to transfer heat from the cells 403 to the horizontal vapor chambers 431 and the vertical vapor chambers 441. In some embodiments, the vertical vapor chambers 441 include a conducting section, as well as internal phase change sections. The conducting portion of the vertical vapor chambers 441 can be used to transfer heat away from the surface of the cells, and the internal phase change sections can provide the heat transfer properties desired. In some embodiments, the vertical vapor chambers 441 can be located in areas where less airflow occurs, in order to interfere less with the cooling airflow, add less flow resistance to the system, and provide heat transfer in areas more susceptible to hot spots. As shown above in FIG. 1, the battery cells can be arranged in a staggered pattern in order to conserve space. This arrangement may also result in a turbulent airflow with pockets of the chassis receiving little or no airflow. In one example embodiment, the surface area of cells 403 which receives more airflow can be exposed to the air (and may possibly include cooling fins like those disclosed above in reference to FIGS. 2-3), while the surface area of the cells 403 which receives less or no airflow can be in contact with one or more vertical vapor chambers 441.

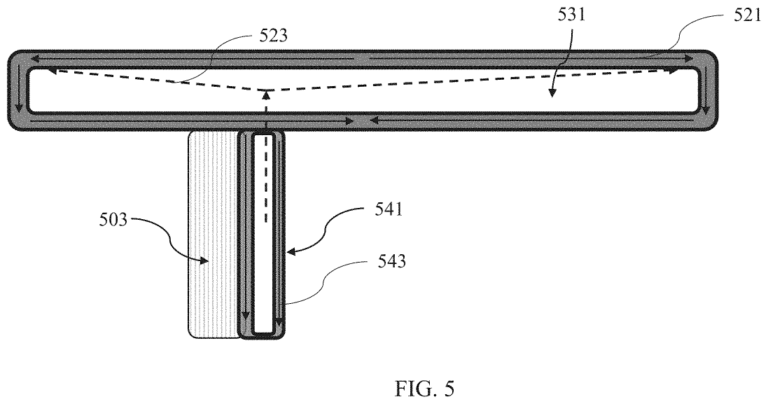

FIG. 5 shows a representation of a battery cell holder design, according to embodiments of the present disclosure. In this simplified representation, a battery cell 503 can be at least partially in contact with a vertical vapor chamber 541 and a horizontal vapor chamber 531. The horizontal vapor chamber 531 includes a fluid path 521 and a vapor path 523. The vertical vapor chamber 541 also includes a fluid path 543. In this embodiment, the vertical vapor chamber 543 assists in holding or mounting the battery cell 503, as well as transferring heat away from the cell 503. In some embodiments, the vertical vapor chamber 541 and the fluid path 543 help with longitudinal heat transfer along the battery cell 503. Because the portion of the battery cell 503 that is covered by the vertical vapor chamber 541 does not benefit sufficiently from forced convection cooling, the vertical vapor chamber 541 itself can provide longitudinal heat transfer along at least a portion of the battery cell 503. In some embodiments, the horizontal vapor chamber 531 and the vertical vapor chamber 541 form an integrated heat transfer system and battery cell holder that is combined as a single unit.

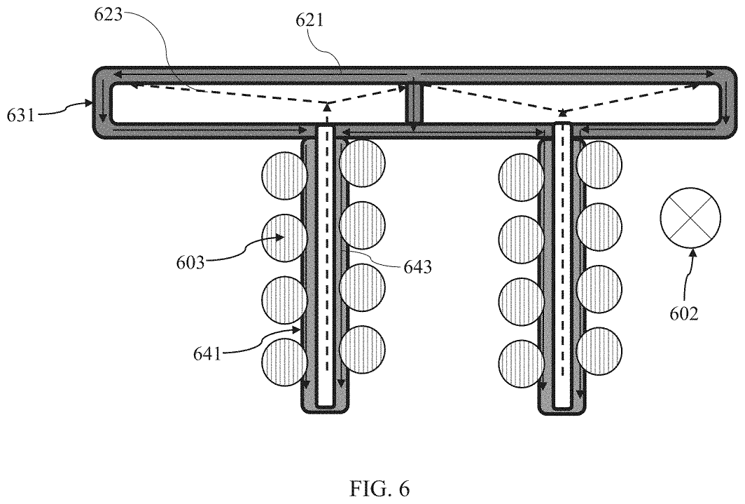

FIG. 6 shows another representation of a battery cell holder design, according to embodiments of the present disclosure. In this simplified representation, a number of battery cells 603 can be at least partially in contact with one or more vertical vapor chambers 641 and one or more horizontal vapor chambers 631. In this embodiment, the airflow path 602 of the cooling air through the system is illustrated as going into the page.

In one embodiment, the horizontal vapor chamber 631 includes a fluid path 621 and a vapor path 623, as well as separate interior compartments for each of the vertical vapor chambers 641. The vertical vapor chamber 641 also includes a fluid path 643. In this embodiment, the vertical vapor chambers 643 assists in holding or mounting the battery cells 603, as well as transferring heat away from the cells 603. One skilled in the art will recognize that different arrangements for the cells 603, vertical vapor chambers 643, and horizontal vapor chambers 631 can be implemented based on different cell layouts, different airflow directions, as well as different cell mounting techniques. In various embodiments, the vertical vapor chambers 643 and horizontal vapor chambers 631 can be assembled as part of a battery cell holder, or they can function as the holder themselves. In this embodiment, a particular internal design structure is shown in FIG. 6 for ease of illustration and explanation. However, this image is not intended to be drawn to scale and is merely representative. The particular vapor chambers may have different internal or external structures from those shown, and the invention is not limited to any particular type of internal structure of vapor chambers. In some embodiments, the horizontal vapor chamber 631 and the vertical vapor chamber 641 form an integrated heat transfer system and battery cell holder that is combined as a single unit.

In some embodiments, the structures described herein, and particularly the structures described in FIGS. 5-6, can be customized for only a portion of the holders of a single BBU or chassis. This can be especially useful for an actual BBU product or a BBU package, which may have different cooling and heat dissipation needs for different battery cells or portions of battery cells. In such a customized embodiment, temperature variations and hot spots within a BBU can be mitigated or targeting on completely avoided. In some embodiments, the battery cell holders described in reference to FIGS. 5-6 can be removably mounted within a chassis of a battery backup unit, and can be replaced with different battery cell holders having different specific structural components. In some embodiments, the design disclosed herein uses heat conduction to solve the thermal gradient within the BBU using air cooling nature.

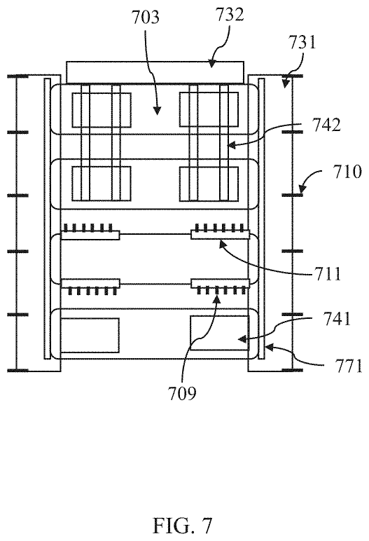

FIG. 7 shows a cross-sectional view of a battery cell holder and cell assembly, according to embodiments of the present disclosure. In this embodiment, a number of battery cells 703 are held in place using sockets within the conducting holders 711 and/or one or more horizontal vapor chambers 731 and vertical vapor chambers 741. The conducting holders 711 can include cooling fins 709 to help dissipate heat away from the battery cells 703. Likewise, one or more of the horizontal vapor chambers 731 can include cooling fins 710 to help dissipate heat away from the horizontal vapor chambers 731. Because the conducting holders 711, the horizontal vapor chambers 731, and the vertical vapor chambers 741 are made of conductive materials (e.g., copper), battery tabs 771 can be placed at the ends of the battery cells 703.

As can be seen in this embodiment, multiple methods can be used for the design and assembly of a single system. In this embodiment, the airflow can be directed into the page, and thus the vertical vapor chambers 741 are located where they minimize their negative impact on airflow, as well as the contacting surface between the battery cells 703 and the airflow. The top vapor chamber 732 can enable an additional design in which a series of vertical vapor chambers 742 (or alternatively heat pipes) can be used for a subset of the battery cells 703. In practice, the types of heat transfer systems and structures used may be determined based on the actual size, cooling needs, and internal cell layout of a BBU. In some embodiments, a holder or chassis can be customized to include additional sensors or protection cables in order to optimize the heat transfer system. The cell arrangements can be in different manners.

In some embodiments, the cell layout may require slight modifications to the socket design for the battery cells. In other embodiments, the cooling solutions disclosed herein can be combined with different airflow management solutions, such as different fan locations and fan selections. In additional embodiments, one or more of the holders can be designed in multiple sections and then assembled as one unit. In such cases, a standard holder design can be used for different BBU modules where different numbers of cells are packaged and or for different BBU modules using different layouts. In some embodiments, each of the heat transfer designs disclosed herein can provide both heat transfer from the battery cells, as well as a holding or fastening function for mounting and securing the battery cells.

One skilled in the art would recognize that various adjustments can be made to the system within the scope of this disclosure. The following clauses and/or examples pertain to specific embodiments or examples thereof. Specifics in the examples may be used anywhere in one or more embodiments. The various features of the different embodiments or examples may be variously combined with some features included and others excluded to suit a variety of different applications. Examples may include subject matter such as a method, means for performing acts of the method, or of an apparatus or system according to embodiments and examples described herein. Various components can be a means for performing the operations or functions described.

One embodiment provides for a battery heat transfer system. The heat transfer system includes a chassis having an inlet end and an outlet end to receive a cooling airflow from the inlet end to the outlet end. The heat transfer system also includes a number of conducting holders for holding a number of battery cells within the chassis. The heat transfer system also includes a heat transfer system configured to transfer heat from the outlet end of the chassis to the inlet end of the chassis. In some embodiments, the heat transfer device comprises one or more heat pipes. In some embodiments, the heat transfer system also includes a condensing plate and an evaporating plate, wherein the heat pipes are configured to transfer cooling fluid between the condensing plate and the evaporating plate. In some embodiments, fluid within the heat pipes flows from the inlet end to the outlet end of the chassis. In some embodiments, vapor within the heat pipes flows from the outlet end to the inlet end of the chassis. In some embodiments, the heat transfer system also includes a plurality of heat transfer fins positioned on one or more of the plurality of conducting holders. In some embodiments, the heat transfer device comprises one or more horizontal vapor chambers. In some embodiments, the heat transfer system also includes a number of cooling fins located on at least one of the horizontal vapor chambers. In some embodiments, the heat transfer system also includes a number of cooling fins located on one or more of the conducting holders. In some embodiments, the heat transfer system also includes one or more vertical vapor chambers in thermal contact with at least one of the conducting holders. In some embodiments, the one or more vertical vapor chambers are located in an area of low airflow within the chassis.

Another embodiment provides for a battery cell holder. The battery cell holder includes at least one horizontal vapor chamber and at least one vertical vapor chamber. The horizontal vapor chamber and the vertical vapor chamber receive and are in thermal contact with at least one battery cell. In some embodiments, the horizontal vapor chambers and the vertical vapor chambers are a battery cell holder within which one or more battery cells can be mounted. In some embodiments, the battery cell holder also includes at least one conducting holder defining a socket for receiving at least one battery cell, wherein the conducting holder conducts heat from the battery cell to the horizontal vapor chamber and the vertical vapor chamber. In some embodiments, the conducting holder defines a number of sockets for receiving a number of battery cells. In some embodiments, the battery cell holder is configured to mount within a portion of a battery backup unit chassis.

Another embodiment provides for a battery backup unit. The battery backup unit includes a battery backup unit chassis having an inlet end and an outlet end to receive a cooling airflow from the inlet end to the outlet end. The battery backup unit also includes conducting holders for holding a number of battery cells. The battery backup unit also includes at least two vapor chambers located within the chassis and in thermal contact with the conducting holders. The vapor chambers transfer heat from the outlet end to the inlet end of the battery backup unit chassis. In some embodiments, the battery backup unit also includes cooling fins located on the conducting holders. In some embodiments, the battery backup unit also includes cooling fins located on the vapor chambers. In some embodiments, the battery backup unit also includes one or more vertical vapor chambers located within the battery backup unit chassis and in thermal contact with the conducting holders.

In the foregoing specification, the invention has been described with reference to specific embodiments thereof. However, various modifications and changes can be made thereto without departing from the broader spirit and scope of the invention. The specification and drawings are, accordingly, to be regarded in an illustrative rather than a restrictive sense.

What is claimed is:

1. A battery heat transfer system, comprising:
a chassis having an inlet end and an outlet end to receive a cooling airflow from the inlet end to the outlet end;
a plurality of conducting holders for holding a plurality of battery cells within the chassis; and
a heat transfer device configured to transfer heat from the outlet end of the chassis to the inlet end of the chassis.

2. The battery heat transfer system of claim 1, wherein the heat transfer device comprises one or more heat pipes.

3. The battery heat transfer system of claim 2, further comprising:
a condensing plate; and
an evaporating plate,
wherein the one or more heat pipes are configured to transfer cooling fluid between the condensing plate and the evaporating plate.

4. The battery heat transfer system of claim 3, wherein fluid within the heat pipes flows from the inlet end to the outlet end of the chassis, and vapor within the heat pipes flows from the outlet end to the inlet end of the chassis.

5. The battery heat transfer system of claim 2, further comprising a plurality of cooling fins positioned on one or more of the plurality of conducting holders.

6. The battery heat transfer system of claim 1, wherein the heat transfer device comprises one or more horizontal vapor chambers.

7. The battery heat transfer system of claim 6, further comprising:
a plurality of cooling fins located on at least one of the one or more horizontal vapor chambers.

8. The battery heat transfer system of claim 6, further comprising:
a plurality of cooling fins located on one or more of the plurality of conducting holders.

9. The battery heat transfer system of claim 6, further comprising:
one or more vertical vapor chambers in thermal contact with at least one of the plurality of conducting holders.

10. The battery heat transfer system of claim 9, wherein the one or more vertical vapor chambers are located in an area of low airflow within the chassis.

11. A battery cell holder, comprising:
at least one horizontal vapor chamber; and
at least one vertical vapor chamber,
wherein the at least one horizontal vapor chamber and the at least one vertical vapor chamber receive and are in thermal contact with at least one battery cell.

12. The battery cell holder of claim 11, wherein the at least one horizontal vapor chamber and the at least one vertical vapor chamber comprise a battery cell holder within which one or more battery cells can be mounted.

13. The battery cell holder of claim 11, further comprising:
at least one conducting holder defining a socket for receiving at least one battery cell, wherein the at least one conducting holder conducts heat from the at least one battery cell to the horizontal vapor chamber and the vertical vapor chamber.

14. The battery cell holder of claim 13, wherein the at least one conducting holder defines a plurality of sockets for receiving a plurality of battery cells.

15. The battery cell holder of claim 11, wherein the battery cell holder is configured to mount within a portion of a battery backup unit chassis.

16. The battery cell holder of claim 11, wherein the at least one horizontal vapor chamber and the at least one vertical vapor chamber comprise an integrated heat transfer system and battery cell holder combined as a single unit.

17. A battery backup unit, comprising:
a battery backup unit chassis having an inlet end and an outlet end to receive a cooling airflow from the inlet end to the outlet end;
a plurality of conducting holders for holding a plurality of battery cells; and
at least two vapor chambers located within the chassis and in thermal contact with the plurality of conducting holders,
wherein the at least two vapor chambers transfer heat from the outlet end to the inlet end of the battery backup unit chassis.

18. The battery backup unit of claim 17, further comprising a plurality of cooling fins located on the plurality of conducting holders.

19. The battery backup unit of claim 17, further comprising a plurality of cooling fins located on the at least two vapor chambers.

20. The battery backup unit of claim 17, further comprising one or more vertical vapor chambers located within the battery backup unit chassis and in thermal contact with the plurality of conducting holders.
